(19) United States
(12) Patent Application Publication
(10) Pub. No.: US 2012/0092566 A1
(43) Pub. Date: Apr. 19, 2012

(54) IMAGE PROCESSING APPARATUS, SOUND PROCESSING METHOD USED FOR IMAGE PROCESSING APPARATUS, AND SOUND PROCESSING APPARATUS

(75) Inventors: Seung-su LEE, Suwon-si (KR); Yun-yong KIM, Suwon-si (KR); Yun-seok KIM, Suwon-si (KR)

(73) Assignee: SAMSUNG ELECTRONICS CO., LTD., Suwon-si (KR)

(21) Appl. No.: 13/158,691

(22) Filed: Jun. 13, 2011

(30) Foreign Application Priority Data
Oct. 19, 2010 (KR) 10-2010-0101619

(51) Int. Cl. H04N 5/60; H04R 29/00

(52) U.S. Cl. 348/738; 381/56; 348/E05.122

(57) ABSTRACT

An image processing apparatus, a sound processing method used for an image processing apparatus, and a sound processing apparatus are provided. The image processing apparatus includes a signal receiver which receives an image signal and an audio signal; an image processor which processes the image signal received by the signal processor to be displayed; and a sound processor which determines a first channel signal and a second channel signal corresponding to positions which are symmetrical based on a standard axis from the audio signal of each channel received by the signal receiver, and processes the first channel signal and the second channel signal based on a change in an energy difference between the first channel signal and the second channel signal.

### CROSS-REFERENCE TO RELATED APPLICATION

This application claims priority from Korean Patent Application No. 10-2010-0101619, filed on Oct. 19, 2010 in the Korean Intellectual Property Office, the disclosure of which is incorporated herein by reference.

### BACKGROUND

1. Field

Apparatuses consistent with exemplary embodiments relate to an image processing apparatus which is capable of receiving an audio signal, a sound processing method used for an image processing apparatus, and a sound processing apparatus, and more particularly, to an image processing apparatus which processes an audio signal so that a user three-dimensionally recognizes a sound according to a position change of a transferring virtual sound source, and a sound processing method for an image processing apparatus.

2. Description of the Related Art

An image processing apparatus is a device which processes an image signal input from the outside based on a preset process to be displayed as an image. The image processing apparatus includes a display panel to display an image by itself, or output a processed image signal to a display apparatus so that an image is displayed in the display apparatus. An example of the former configuration is a set-top box (STB) receiving a broadcasting signal, and an example of the latter configuration is a television (TV) connected to the STB to display a broadcasting image.

A broadcasting signal received by the image processing apparatus includes not only an image signal but an audio signal. In this instance, the image processing apparatus extracts an image signal and an audio signal from a broadcasting signal and respectively processes the signals based on separate processes. Audio signals correspond to a plurality of channels so that a user can three-dimensionally recognize an output sound, and the image processing apparatus adjusts the audio signals of the plurality of channels corresponding to a number of channels of a speaker provide in the image processing apparatus and outputs the signals to the speaker.

For example, when audio signals of 5.1 channels are transmitted to the image processing apparatus, and the image processing apparatus includes two right and left channel speakers, the image processing apparatus processes the respective channels of the audio signals, dividing right and left, and adds and outputs right signals and left signals of the respective channels corresponding to right and left speakers. Then, the user recognizes an output sound three-dimensionally.

### SUMMARY

According to an aspect of an exemplary embodiment, there is provided an image processing apparatus including: a signal receiver which receives an image signal and an audio signal; an image processor which processes the image signal received by the signal processor to be displayed; and a sound processor which determines a first channel signal and a second channel signal corresponding to positions which are symmetrical, and processes the first channel signal and the second channel signal based on a change in an energy difference between the first channel signal and the second channel signal. The positions are symmetrical based on a standard axis from the audio signal of each channel received by the signal receiver.

The sound processor may calculate positional change information according to a transfer of a sound source based on the change in the energy difference and selects a preset head-related transfer function (HRTF) coefficient corresponding to the calculated positional change information to perform filtering on the first channel signal and the second channel signal.

The positional change information may include information about a change of a horizontal angle and a vertical angle of the sound source with respect to a user.

The sound processor may successively change at least one of the horizontal angle and the vertical angle within a predetermined range when the sound source is determined not to transfer for a preset time.

The sound processor may include: a mapping unit which maps the audio signal of each channel into the first channel signal and the second channel signal; a localization unit which calculates a motion vector value of a sound source based on the change in the energy difference between the first channel signal and the second channel signal; and a filter unit which performs filtering on the first channel signal and the second channel signal using an HRTF coefficient corresponding to the calculated motion vector value.

The sound processor may analyze a correlation between the first channel signal and the second channel signal, and calculate the change in the energy difference between the first channel signal and the second channel signal when the correlation between the first channel signal and the second channel signal is determined to be substantially close as a result of the correlation analysis.

The change in the energy difference may include a change in a sound level difference between the first channel signal and the second channel signal.

The standard axis may include a horizontal axis or a vertical axis including a position of a user.

According to an aspect of another exemplary embodiment, there is provided a sound processing method is provided for use for an image processing apparatus, the sound processing method including determining a first channel signal and a second channel signal corresponding to positions which are symmetrical based on a standard axis from audio signals of a plurality of channels transmitted from the outside; and processing for the first channel signal and the second channel signal based on a change in an energy difference between the first channel signal and the second channel signal.

The processing for the first channel signal and the second channel signal may include calculating positional change information according to a transfer of a sound source based on the change in the energy difference; and selecting a preset head-related transfer function (HRTF) coefficient corresponding to the calculated positional change information to perform filtering on the first channel signal and the second channel signal.

The positional change information may include information about a change of a horizontal angle and a vertical angle of the sound source with respect to a user.

The calculating the positional change information according to the transfer of the sound source may include successively changing at least one of the horizontal angle and the vertical angle within a predetermined range when the sound source is determined not to transfer for a preset time.

The processing for the first channel signal and the second channel signal may include calculating a motion vector value of a sound source based on the change in the energy difference between the first channel signal and the second channel signal, and filtering the first channel signal and the second channel signal using an HRTF coefficient corresponding to the calculated motion vector value.

The processing for the first channel signal and the second channel signal may include analyzing a correlation between the first channel signal and the second channel signal, and calculating the change in the energy difference between the first channel signal and the second channel signal when the correlation between the first channel signal and the second channel signal is determined to be substantially close as a result of the correlation analysis.

The change in the energy difference may include a change in a sound level difference between the first channel signal and the second channel signal.

The standard axis may include a horizontal axis or a vertical axis including a position of a user.

According to an aspect of another exemplary embodiment, there is provided a sound processing apparatus including: a signal receiver which receives an audio signal; and a sound processor which determines a first channel signal and a second channel signal corresponding to positions which are symmetrical based on a standard axis from the audio signal of each channel received by the signal receiver, and processes the first channel signal and the second channel signal based on a change in an energy difference between the first channel signal and the second channel signal.

### BRIEF DESCRIPTION OF THE DRAWINGS

The above and/or other aspects will become apparent from the following description of exemplary embodiments, taken in conjunction with the accompanying drawings, in which:

FIG. 1 is a block diagram illustrating a configuration of an image processing apparatus according to an exemplary embodiment;

FIG. 2 illustrates an example of a channel arrangement in a sound image with respect to an audio signal transmitted to the image processing apparatus of FIG. 1;

FIG. 3 is a block diagram illustrating a configuration of a sound processor in the image processing apparatus of FIG. 1;

FIG. 4 illustrates an example of a virtual sound source transferring with respect to a user in the image processing apparatus of FIG. 1;

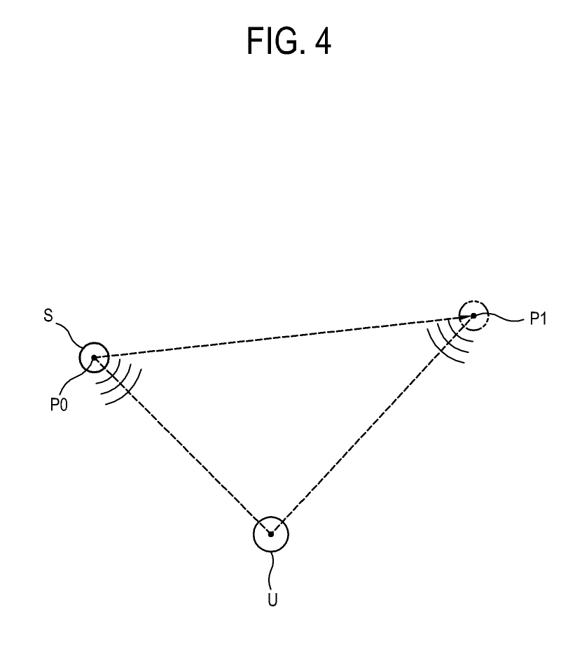

FIG. 5 illustrates an example of three-dimensionally showing a transfer from a first position to a second position in the image processing apparatus of FIG. 1;

FIG. 6 is a flowchart illustrating a control method of the image processing apparatus of FIG. 1 according to an exemplary embodiment; and

FIG. 7 is a block diagram illustrating a configuration of a sound processing apparatus according to another exemplary embodiment.

### DETAILED DESCRIPTION OF EXEMPLARY EMBODIMENTS

Below, exemplary embodiments will be described in detail with reference to accompanying drawings so as to be realized by a person having ordinary knowledge in the art. The exemplary embodiments may be embodied in various forms without being limited to the exemplary embodiments set forth herein. Descriptions of well-known parts are omitted for clarity and conciseness, and like reference numerals refer to like elements throughout.

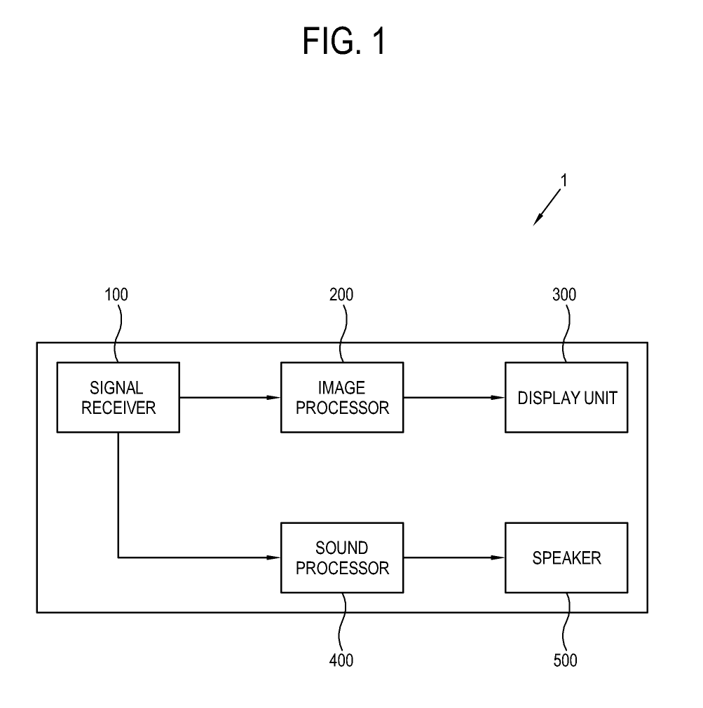

FIG. 1 is a block diagram illustrating a configuration of an image processing apparatus 1 according to an exemplary embodiment. The image processing apparatus 1 includes a signal receiver 100 to receive a signal from an external source, an image processor 200 to process an image signal among signals received by the signal processor 100, a display unit 300 to display an image based on an image signal processed by the image processor 200, a sound processor 400 to process an audio signal among signals received by the signal receiver 100, and a speaker 500 to output a sound based on an audio signal processed by the sound processor 400.

In the exemplary embodiment, the image processing apparatus 1 includes the display unit 300, but is not limited thereto. For example, the exemplary embodiment may be realized by an image processing apparatus which does not include the display unit 300, or by various sound processing apparatuses to process and output an audio signal, not limited to the image processing apparatus, as would be understood by those skilled in the art.

The signal receiver 100 receives at least one of an image signal and an audio signal from various sources (not shown), not limited. The signal receiver 100 may receive a radio frequency (RF) signal transmitted from a broadcasting station (not shown) wirelessly, or receives image signals in composite video, component video, super video, SCART (Syndicat des Constructeurs d'Appareils Radiorécepteurs et Téléviseurs), and high definition multimedia interface (HDMI) standards by wireline. Other standards as would be understood by those skilled in the art may be substituted therefore. Alternatively, the signal processor 100 may be connected to a web server (not shown) to receive a data packet of web contents.

When the signal receiver 100 receives a broadcasting signal, the signal receiver 100 tunes the received broadcasting signal into an image signal and an audio signal, and transmits the image signal and the audio signal to the image processor 200 and to the sound processor 400, respectively.

The image processor 200 performs various types of image (e.g., preset) processing on an image signal transmitted from the signal receiver 100. The image processor 200 outputs a processed image signal to the display unit 300 so that an image is displayed on the display unit.

The image processor 200 may perform various types of image processing, including, but not limited to, decoding corresponding to various image formats, de-interlacing, frame refresh rate conversion, scaling, noise reduction to improve image quality, detail enhancement, and the like. The image processor 200 may be provided as a separate component to independently conduct each process, or an integrated component which is multi-functional, such as a system-on-chip.

The display unit 300 displays an image based on an image signal output from the image processor 200. The display unit 300 may be configured in various types using liquid crystals, plasma, light emitting diodes, organic light emitting diodes, a surface conduction electron emitter, a carbon nano-tube, nano-crystals, or the like, but is not limited thereto. Other equivalent structures that performing the displaying function may be substituted therefore, as would be understood by those skilled in the art.

The sound processor 400 processes an audio signal received from the signal receiver 100 and outputs the signal to the speaker 500. When audio signals of a plurality of channels are received, the sound processor 400 processes an audio signal of each channel to correspond to a channel of the speaker 500. For example, when audio signals of five channels are received, the speaker corresponding to two channels, the sound processor 400 reconstitutes the audio signals of the five channels for a left channel and a right channel to output to the speaker 500. Accordingly, the speaker 500 outputs an audio signal received for each of right and left channels as a sound.

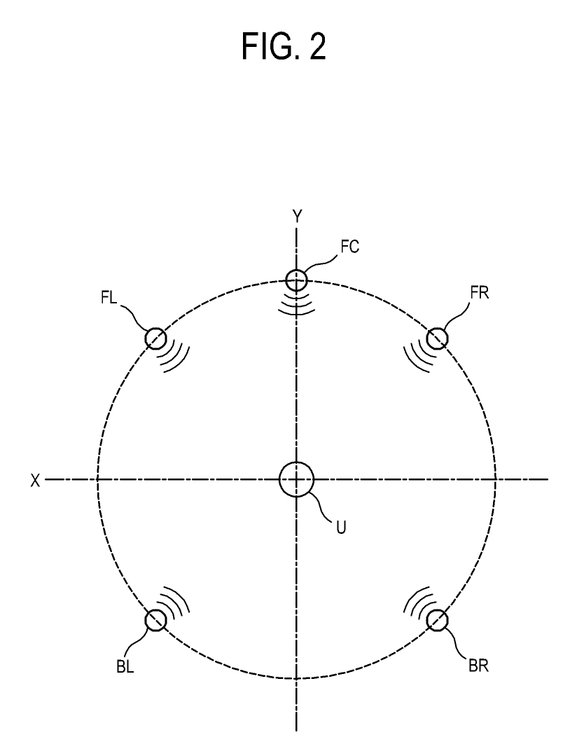

A channel of an audio signal received by the sound processor 400 is described below with reference to FIG. 2, which illustrates an exemplary channel arrangement in a sound image with respect to audio signals of five channels. In the exemplary embodiment, audio signals correspond to five channels, but a number of channels of audio signals is not particularly limited.

As shown in FIG. 2, a user U is in a center position of the sound image where an X-axis in a right-and-left direction is at right angles to a Y-axis in a front-and-back direction. The audio signals of the five channels includes a front left channel FL, a front right channel FR, a front center channel FC, a back/surround left channel BL, and a back/sound right channel BR based on the user U. The respective channels FL, FR, FC, BL, and BR correspond to positions around the user U in the sound image, and thus the user may recognize a sound three-dimensionally when an audio signal is output as the sound.

To process audio signals of a plurality of channels so that the user recognizes a sound three-dimensionally, the sound processor 400 performs filtering on an audio signal of each channel through a head-related transfer function (HRTF) (e.g., preset).

An HRTF is a function representing a change in a sound wave which is generated due to an auditory system of a person having two ears spaced away with the head positioned therebetween, that is, an algorithm mathematically representing an extent to which transmission and progress of a sound is affected by the head of the user. The HRTF may dispose a channel of an audio signal corresponding to a particular position of a sound image by reflecting various elements, such as an inter-aural level difference (ILD), an inter-aural time difference (ITD), diffraction and reflection of a sound, or the like. An HRTF algorithm is known in a field of sound technology, and thus description thereof is omitted.

Due to application of the HRTF algorithm to an audio signal, the user may distinguish sound images in a right-and-left direction but may not distinguish sound images in a front-and-back direction.

For example, so that the user U recognizes a sound three-dimensionally, a sound image of audio signals of back channels BL and BR should be formed at back of the user U. However, front/back confusion, where the sound image is formed in a position which is not at back of the user U, but is, for example, in front of the user U or in the head of the user U, may occur due to characteristics of the HRTF. Alternatively, the sound image of the audio signals of the back left channel BL and the back right channel BR may not be formed respectively in a back left side and in a back right of the user U but may be formed in a back center position.

According to the exemplary embodiment, when audio signals of a plurality of channels are received, the sound processor 400 determines a first channel signal and a second channel signal corresponding to positions which are symmetric based on a standard axis in a sound image from the image signals. Then, the sound processor 400 processes the first channel signal and the second channel signal based on a change in an energy difference between the first channel signal and the second channel signal. Accordingly, the front/back confusion is prevented, and the user may recognize a sound three-dimensionally.

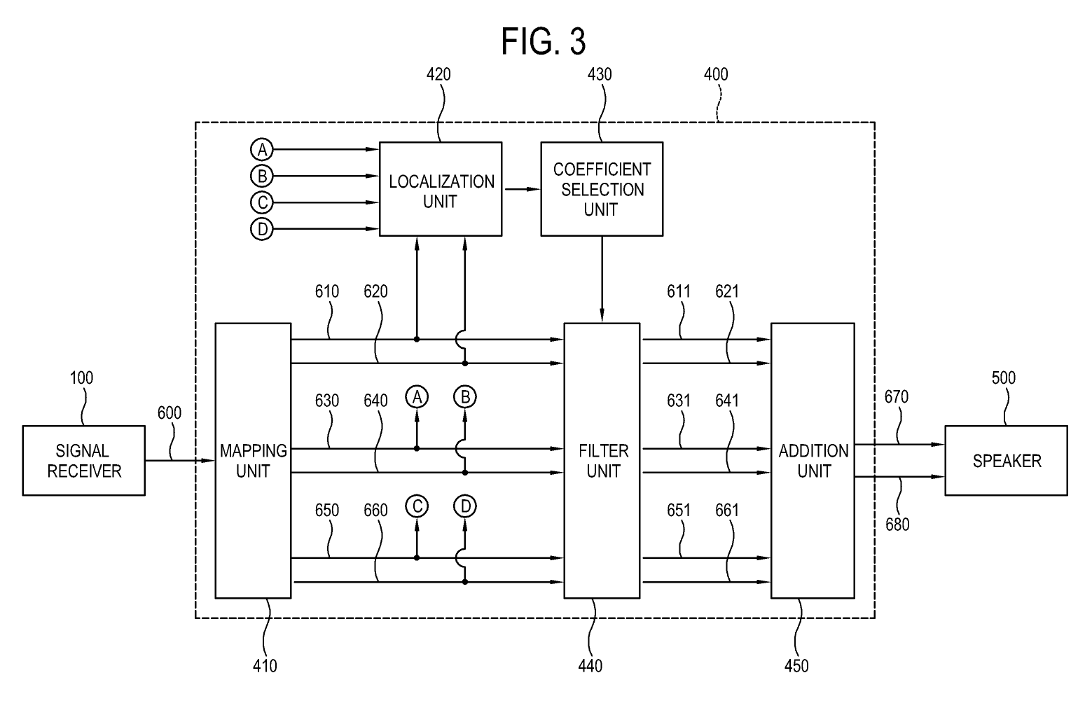

Hereinafter, a configuration of the sound processor 400 according to the exemplary embodiment is further described with reference to FIG. 3, which illustrates the configuration of the sound processor 400.

As shown in FIG. 3, the sound processor 400 includes a mapping unit 410 to map an audio signal of each channel received by the signal receiver 100 into a first channel signal and a second channel signal which are symmetrical, a localization unit 420 to calculate positional change information according to a transfer of a sound source based on a change in an energy difference between a first channel signal and a second channel signal, a coefficient selection unit 430 to select an HRTH coefficient corresponding to positional change information calculated by the localization unit 420, a filter unit 440 to HRTF-filter a first channel signal and a second channel signal by reflecting an HRTF coefficient selected by the coefficient selection unit 430, and an addition unit 450 to arrange and output an audio signal of each channel output from the filter unit 440 corresponding to the speaker 500.

For example, when audio signals of five channels 600 are received from the signal receiver 100, the mapping unit 410 maps the audio signals of the respective channels 600 into a pair of signals corresponding to positions which are symmetrical based on a standard axis (e.g. preset) in a sound image. Hereinafter, signals of two channels in the mapped pair are referred to as a first channel signal and a second channel signal.

The standard axis may be designated as a horizontal axis or a vertical axis including a position of the user U in the sound image. For example, referring to FIG. 2, the signals 600 are first mapped into a first pair of a channel FL and a channel FR and a second pair of a channel BL and a channel BR based on the Y-axis which is the horizontal axis including the user U. A channel FC does not have a corresponding channel disposed symmetrically with respect to the X-axis, and thus the mapping unit 410 excludes the channel FC in mapping to be separately processed, or performs mapping so that a third pair is formed to include the channel FC and a channel obtained by summing the channel BL and the channel BR.

The mapping unit 410 maps the audio signals 600 into three pairs 610 and 620, 630 and 640, and 650 and 660 to output. Hereinafter, an example of a processing configuration is described with respect to the first pair of signals 610 and 620, and the example may be similarly applied to the other pairs of signals 630, 640, 650, and 660.

The localization unit 420 calculates a transferred position of a virtual sound source S with respect to the user U based on a change in an energy difference between the pair of the first channel signal 610 and the channel signal 620 output from the mapping unit 410, as shown in FIG, which illustrates an example of the sound source S transferring with respect to the user U.

When the sound source S located in an initial position P0 is transferred to a position P1, a level and a perceived distance of a sound recognized by the user U with two ears is changed based on a chorological transfer of the sound source S. Thus, when the change in the energy difference between the first channel signal 610 and the second channel signal 620 which are symmetrical based on the standard axis is calculated, a relative positional change of the sound source S may be calculated. Here, the change in the energy difference includes a change in a sound level difference between the first channel signal 610 and the second channel signal 620.

When an energy amount of each of the first channel signal 610 and the second channel signal 620 is changed over time, a change in an energy difference is calculated into a motion vector value to calculate a relative transferred position of the sound source S.

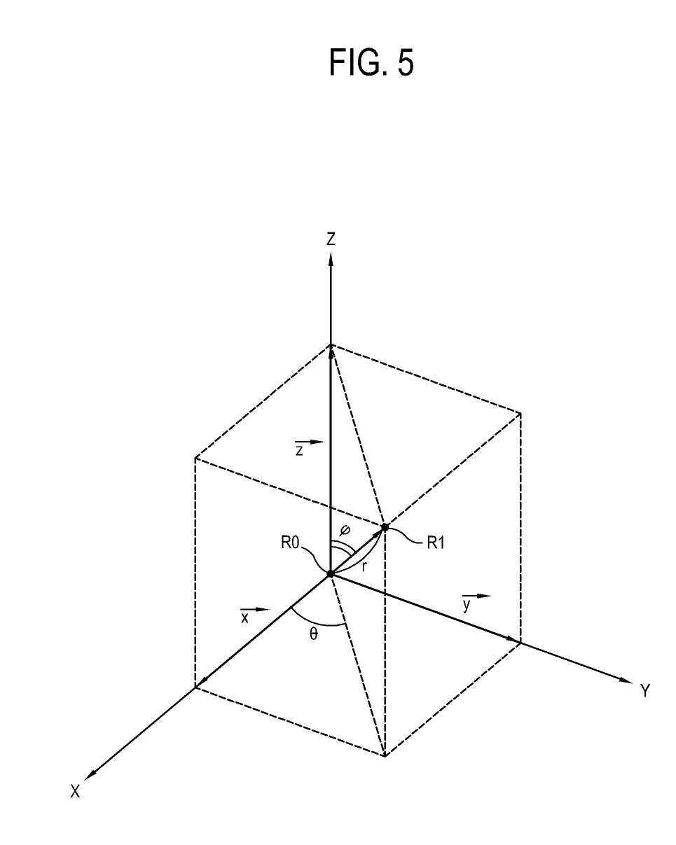

An example of three-dimensionally displaying a position of the sound source S with respect to the user U is described with reference to FIG. 5, which illustrates an example of three-dimensionally illustrating relations between vectors relation based on a positional change when a transfer is made from a position R0 to a position R1.

As shown in FIG. 5, when an object transfers from the position R0 to the position R1 with respect to the X-axis, the Y-axis, and a Z-axis, a motion vector value is expressed as \vec{a}(r, θ, Φ), which is represented by the following equation.

\vec{a}(r, θ, Φ)=\vec{x}·sin Φ·cos θ+\vec{y}·sin Φ·sin θ+\vec{z}·cos Φ

r is a distance between the position R0 and the position R1, θ is a horizontal angle change, and Φ is a vertical angle change.

The localization unit 420 calculates positional change information according to a transfer of the sound source S, that is, a motion vector value of the sound source S, based on a change in an energy difference between the first channel signal 610 and the second channel signal 620. The motion vector value includes horizontal angle change information and vertical angle change information of the sound source S, and the localization unit 420 transmits the calculated positional change information of the sound source S to the coefficient selection unit 430, as shown in FIG. 3.

The localization unit 420 analyzes a correlation between the first channel signal 610 and the second channel signal 620 before the change in the energy difference between the first channel 610 and the second channel 620 is calculated. A correlation analysis refers to a statistical analysis method of analyzing relational closeness or similarity between two signals/codes/data to be compared, that is, a correlation. The correlation analysis is a known statistical analysis method, and thus description thereof is omitted.

As a result of the correlation analysis, when a correlation between the first channel signal 610 and the second channel signal 620 is substantially close, the localization unit 420 calculates the change in the energy difference. When a correlation between the first channel signal 610 and the second channel signal 620 is not substantially close, the localization unit 420 does not calculate the change in the energy difference. This is because the localization unit 420 determines that the former case is due to a transfer of the sound source S, and determines that the latter case is due to a transfer of a different sound source other than the sound source S.

That is, the localization unit 420 determines whether the change in the energy difference between the first channel signal 610 and the second channel signal 620 is due to the same sound source S through the correlation analysis. When the change in the energy difference is not due to the same sound source S, the localization unit 420 does not allow performing a change of an HRTF coefficient reflected when the first channel signal 610 and the second channel signal 620 are processed by the filter unit 440.

The coefficient selection unit 430 stores an HRTF coefficient corresponding to positional change information about the sound source S, that is, horizontal and vertical angle changes, in a table. When positional change information about the sound source S is received from the localization unit 420, the coefficient selection unit 430 selects and transmits an HRTF coefficient corresponding to the received positional change information to the filter unit 440.

In the exemplary embodiment, the coefficient selection unit 430 stores an HRTF coefficient in a table, but is not limited thereto. The coefficient selection unit 430 may deduce a corresponding HRTF coefficient from positional change information of the sound source S through various algorithms (e.g., preset).

The filter unit 440 performs filtering on the signals of the respective channels 610, 620, 630, 640, 650, and 660 output from the mapping unit 410 by applying the HRTF. In particular, when an HRTF coefficient corresponding to the first channel signal 610 and the second channel signal 620 is received from the coefficient selection unit 430, the filter unit 440 reflects the received coefficient to filter-process for the first channel signal 610 and the second channel signal 620.

The filter unit 440 filters the remaining signals of the respective channels 630, 640, 650, and 660 in the substantially same manner, and outputs filter-processed for signals of the respective channels 611, 621, 631, 641, 651, and 661 to the addition unit 450.

The addition unit 450 reconstitutes the audio signals of the respective channels 611, 621, 631, 641, 651, and 661 output from the filter unit 440 corresponding to a number of channels of the speaker 500, for example, two channels.

For example, the addition unit 450 may reconstitute the audio signals 611, 621, 631, 641, 651, and 661 into a left channel signal 670 and a right channel signal 680 to output to the speaker 500. Here, various reconstitution methods may be used as would be understood by those skilled in the art, and descriptions thereof are omitted.

As described above, in the exemplary embodiment, a positional change of the sound source S according to a transfer of the sound source is deduced, and HRTF filtering may be performed, reflecting a different coefficient with respect to each channel of an audio signal corresponding to the deduced positional change of the sound source S. Accordingly, the user may three-dimensionally recognize a sound.

When the sound source S is determined not to transfer for a time (e.g., preset), the sound processor 400 successively changes at least one of a horizontal angle and a vertical angle within a range (e.g., predetermined) to prepare for a case where the user U misses a current position of the sound source S, that is, the user does not recognize the position of the sound source S, over time in the state that the sound source S stops.

Accordingly, when the sound source S transfers from the initial position P0 to the position P1 and then stops, the sound processor 400 successively changes at least one of the horizontal angle and the vertical angle of the sound source S within the range (e.g., predetermined). Accordingly, the user U may clearly recognize a position of a sound source S.

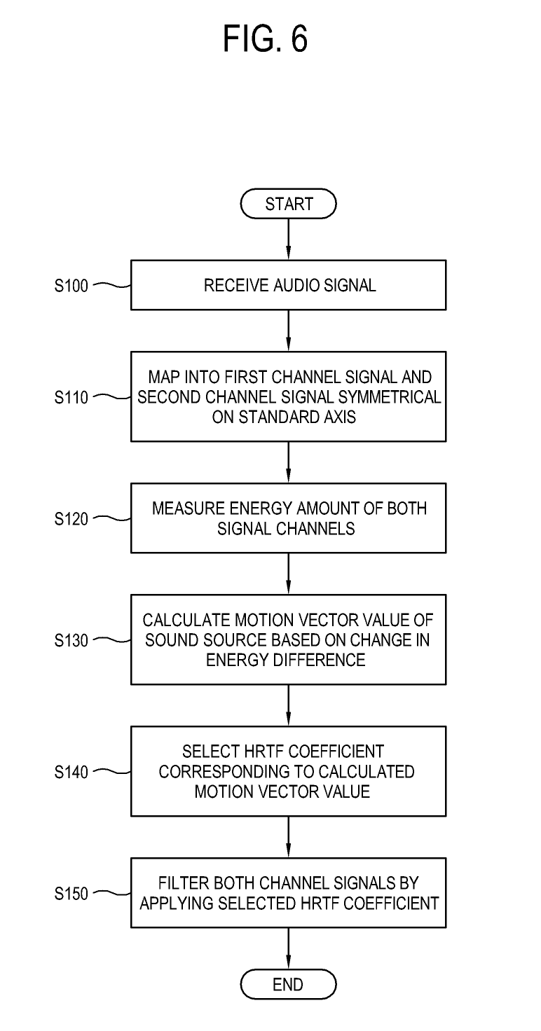

Hereinafter, a sound processing method of the image processing apparatus 1 according to the embodiment (e.g., exemplary) is described with reference to FIG. 6, which is a flowchart illustrating an exemplary sound processing method.

When an audio signal is transmitted to the image processing apparatus 1 (S100), the sound processor 400 maps the audio signal into a first channel signal 610 and a second channel signal 620 which are symmetrical on a standard axis (e.g., preset) in a sound image (S110).

The sound processor 400 measures an energy amount of each of the first channel signal 610 and the second channel signal 620 (S120) and calculates a motion vector value of a sound source S based on a change in an energy difference between the first channel signal 610 and the second channel signal 620 (S130).

The sound processor 400 selects an HRTF coefficient corresponding to the calculated motion vector value (S140) and performs HRTF filtering on the first channel signal 610 and the second channel signal 620 by applying the selected HRTF coefficient (S150).

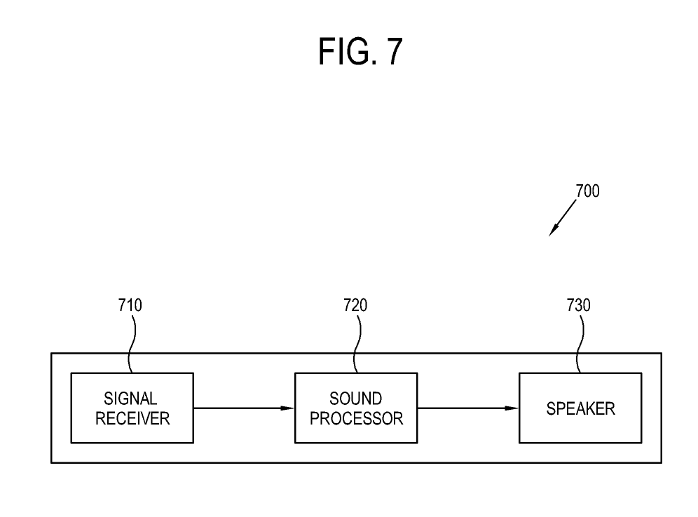

It is described that the exemplary embodiment is applied to the image processing apparatus 1, but the exemplary embodiment is also applied to the sound processing apparatus 700, which will be described below with reference to FIG. 7, which is a block diagram illustrating a configuration of the sound processing apparatus 700 according to another exemplary embodiment.

The sound processing apparatus 700 according to the exemplary embodiment includes a signal receiver 710 to receive an audio signal from the outside, a sound processor 720 to process an audio signal received by the signal receiver 710, and a speaker 730 to output a sound based on an audio signal processed by the sound processor 720.

The signal receiver 710, the sound processor 720, and the speaker 730 may be substantially similar to the signal receiver 100, the sound processor 400, and the speaker 500 described above, and thus descriptions thereof will be omitted for clarity and conciseness.

The above-described embodiments can also be embodied as computer readable codes which are stored on a computer readable recording medium (for example, non-transitory, or transitory) and executed by a computer or processor. The computer readable recording medium is any data storage device that can store data which can be thereafter read by a computer system, including the video apparatus.

Examples of the computer readable recording medium include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so that the computer readable code is stored and executed in a distributed fashion. Also, functional programs, codes, and code segments for accomplishing the embodiments can be easily construed by programmers skilled in the art to which the disclosure pertains. It will be understood that various modifications may be made. For example, suitable results may be achieved if the described techniques are performed in a different order and/or if components in a described system, architecture, device, or circuit are combined in a different manner and/or replaced or supplemented by other components or their equivalents.

Although exemplary embodiments have been shown and described, it will be appreciated by those skilled in the art that changes may be made in these exemplary embodiments without departing from the principles and spirit of the inventive concept, the scope of which is defined in the appended claims and their equivalents. For example, the above embodiments are described with a TV as an illustrative example, but the display apparatus of the embodiments may be configured as a smart phone, a mobile phone, and the like.

What is claimed is:

1. An image processing apparatus comprising:
a signal receiver which receives an image signal and an audio signal;
an image processor which processes the image signal received by the signal processor to be displayed; and
a sound processor which determines a first channel signal and a second channel signal corresponding to positions which are symmetrical based on a standard axis from the audio signal of each channel received by the signal receiver, and processes the first channel signal and the second channel signal based on a change in an energy difference between the first channel signal and the second channel signal.

2. The image processing apparatus of claim 1, wherein the sound processor calculates positional change information according to a transfer of a sound source based on the change in the energy difference and selects a head-related transfer function coefficient corresponding to the calculated positional change information to perform filtering on the first channel signal and the second channel signal.

3. The image processing apparatus of claim 2, wherein the positional change information comprises information about a change of a horizontal angle and a vertical angle of the sound source with respect to a user.

4. The image processing apparatus of claim 3, wherein the sound processor successively changes at least one of the horizontal angle and the vertical angle within a range when the sound source is determined not to transfer for a certain amount of time.

5. The image processing apparatus of claim 1, wherein the sound processor comprises:
a mapping unit which maps the audio signal of each channel into the first channel signal and the second channel signal;
a localization unit which calculates a motion vector value of a sound source based on the change in the energy difference between the first channel signal and the second channel signal; and
a filter unit which performs filtering on the first channel signal and the second channel signal using an HRTF coefficient corresponding to the calculated motion vector value.

6. The image processing apparatus of claim 1, wherein the sound processor analyses a correlation between the first channel signal and the second channel signal, and calculates the change in the energy difference between the first channel signal and the second channel signal when the correlation between the first channel signal and the second channel signal is determined to be substantially close as a result of the correlation analysis.

7. The image processing apparatus of claim 1, wherein the change in the energy difference comprises a change in a sound level difference between the first channel signal and the second channel signal.

8. The image processing apparatus of claim 1, wherein the standard axis comprises a horizontal axis or a vertical axis including a position of a user.

9. A sound processing method comprising:
determining a first channel signal and a second channel signal corresponding to positions which are substantially symmetrical based on a standard axis from audio signals of a plurality of channels transmitted from the outside; and
processing for the first channel signal and the second channel signal based on a change in an energy difference between the first channel signal and the second channel signal.

10. The sound processing method of claim 9, wherein the processing for the first channel signal and the second channel signal comprises:
calculating positional change information according to a transfer of a sound source based on the change in the energy difference; and
selecting a head-related transfer function (HRTF) coefficient corresponding to the calculated positional change information to perform filtering on the first channel signal and the second channel signal.

11. The sound processing method of claim 10, wherein the positional change information comprises information about a change of a horizontal angle and a vertical angle of the sound source with respect to a user.

12. The sound processing method of claim 11, wherein the calculating the positional change information according to the transfer of the sound source comprises successively changing at least one of the horizontal angle and the vertical angle within a range when the sound source is determined not to transfer for a time.

13. The sound processing method of claim 9, wherein the processing for the first channel signal and the second channel signal comprises:
calculating a motion vector value of a sound source based on the change in the energy difference between the first channel signal and the second channel signal; and
filtering the first channel signal and the second channel signal using an HRTF coefficient corresponding to the calculated motion vector value.

14. The sound processing method of claim 9, wherein the processing for the first channel signal and the second channel signal comprises:
analyzing a correlation between the first channel signal and the second channel signal; and
calculating the change in the energy difference between the first channel signal and the second channel signal when the correlation between the first channel signal and the second channel signal is determined to be substantially close as a result of the correlation analysis.

15. The sound processing method of claim 9, wherein the change in the energy difference comprises a change in a sound level difference between the first channel signal and the second channel signal.

16. The sound processing method of claim 9, wherein the standard axis comprises a horizontal axis or a vertical axis including a position of a user.

17. A sound processing apparatus comprising:
a signal receiver which receives an audio signal; and
a sound processor which determines a first channel signal and a second channel signal corresponding to positions which are symmetrical based on a standard axis from the audio signal of each channel received by the signal receiver, and processes the first channel signal and the second channel signal based on a change in an energy difference between the first channel signal and the second channel signal.

18. The image processing apparatus of claim 1, wherein the energy difference between the first channel signal and the second channel signal is determined, when an object transfers from a first position to a second position with respect to an X-axis, a Y-axis, and a Z-axis, according to a motion vector value expressed as \vec{a}(r, θ, Φ), which is represented by:
\vec{a}(r, θ, Φ)=\vec{x}·sin Φ·cos θ+\vec{y}·sin Φ·sin θ+\vec{z}·cos Φ
wherein r is a distance between the first position and the second position, θ is a horizontal angle change, and Φ is a vertical angle change.

19. A computer-readable medium including a set of instructions for performing image processing, the instructions comprising:
determining a first channel signal and a second channel signal corresponding to positions which are substantially symmetrical based on a standard axis from audio signals of a plurality of channels transmitted from the outside; and
processing for the first channel signal and the second channel signal based on a change in an energy difference between the first channel signal and the second channel signal.
